(19) United States
(12) Patent Application Publication
(10) Pub. No.: US 2012/0102922 A1
(43) Pub. Date: May 3, 2012

(54) METHOD OF SIZING A HEATING CORE OF AN EXHAUST HEATER FOR AN EXHAUST TREATMENT SYSTEM OF A VEHICLE

(75) Inventors: Karthik Ramanathan, Bangalore (IN); Se H. Oh, Troy, MI (US)

(73) Assignee: GM GLOBAL TECHNOLOGY OPERATIONS, INC., Detroit, MI (US)

(21) Appl. No.: 12/915,640

(22) Filed: Oct. 29, 2010

(51) Int. Cl. F01N 3/00; B23Q 17/00

(52) U.S. Cl. 60/274; 29/407.05

(57) ABSTRACT

A method of sizing a heating core of an exhaust heater for an exhaust gas treatment system includes measuring the cumulative hydrocarbon or carbon monoxide emissions from the exhaust gas for multiple volumetric sizes of the heating core when heated in accordance with a heating strategy. Alternatively, a model of the treatment system may be used to predict the cumulative hydrocarbon or carbon monoxide emissions. The method further includes selecting the volumetric size of the heating core that is associated with the lowest cumulative hydrocarbon or carbon monoxide emissions level from the measured or predicted hydrocarbon or carbon monoxide emissions when the exhaust gas is heated in accordance with the heating strategy. The heating strategy may include pre-crank heating, or a combination of pre-crank heating and post-crank heating.

### TECHNICAL FIELD

The invention generally relates to a method of treating a flow of exhaust gas from an internal combustion engine, and more specifically to a method of sizing a heating core for an exhaust heater of an exhaust gas treatment system of a hybrid vehicle.

### BACKGROUND

Vehicles with an Internal Combustion Engine (ICE) include an exhaust gas treatment system for reducing the toxicity of the exhaust gas from the engine. The treatment system typically includes a main catalytic converter, which includes a main catalyst that reduces nitrogen oxides in the exhaust gas to nitrogen and carbon dioxide or water, as well as oxidizes carbon monoxide (CO) and unburnt hydrocarbons (HCs) to carbon dioxide and water. The main catalyst may include, but is not limited to, Platinum Group Metals (PGM). The main catalyst must be heated to a light-off temperature of the main catalyst before the main catalyst becomes operational. Accordingly, the exhaust gas must heat the main catalyst to the light-off temperature before the reaction between the main catalyst and the exhaust gas begins. The majority of the pollutants, particularly the majority of the CO and HCs emitted during the operation of the engine occur prior to the main catalyst reaching the light-off temperature.

In order to speed the heating of the main catalyst to the light-off temperature and reduce the pollutants prior to the main catalyst reaching the light-off temperature, the exhaust gas treatment system may include a light-off catalyst that is disposed upstream of the main catalyst. The light-off catalyst, due to a high PGM content, readily promotes exothermic reactions, such as the oxidation of the CO and HCs to reduce the pollutant concentrations and to generate additional heat, which is transferred to the main catalyst to reduce the time to heat the main catalyst to the light-off temperature.

Additionally, some vehicles may include an exhaust gas heater, such as but not limited to an electric heater, to further heat the exhaust gas to reduce the time to heat the main catalyst to the light-off temperature. In conventional vehicles that are only powered by the internal combustion engine, the exhaust gas heater is limited to heating the exhaust gas only after the engine is started, i.e., post crank heating. In hybrid vehicles that further include an ICE/electric motor combination for powering the vehicle, the hybrid vehicle may power the exhaust gas heater prior to starting the engine, i.e., pre-crank heating using the battery, thereby further increasing the amount of heat supplied to the exhaust gas heater and reducing the time to heat the main catalyst to the light-off temperature once the engine is started.

### SUMMARY

A method of treating a flow of exhaust gas from an internal combustion engine is provided. The method includes heating the exhaust gas with an exhaust heater in accordance with a heating strategy, wherein the exhaust heater includes a heating core sized to minimize toxic emissions in the exhaust gas when the exhaust gas is heated in accordance with the heating strategy. The method further includes exothermically oxidizing carbon monoxide and hydrocarbons in the exhaust gas with a light-off catalyst disposed downstream of the exhaust heater to generate heat. The method further includes treating the exhaust gas with a main catalyst disposed downstream of the light-off catalyst to reduce toxic emissions in the exhaust gas.

A method of sizing a volume of a heating core for an exhaust heater of an exhaust gas treatment system is also provided. The method includes measuring the cumulative toxic emissions leaving a main catalyst of the exhaust gas treatment system for various volumetric sizes of a heating core of an exhaust heater when the exhaust gas is heated in accordance with a heating strategy. The method further includes selecting the volumetric size of the heating core that is associated with the lowest cumulative toxic emissions level from the measured cumulative toxic emissions at the various volumetric sizes of the heating core when the exhaust gas is heated in accordance with the heating strategy.

A method of sizing a volume of a heating core for an exhaust heater of an exhaust gas treatment system is also provided. The method includes modeling the operation of the gas treatment system. The model is used to predict the cumulative toxic emissions leaving a main catalyst of the exhaust gas treatment system for various volumetric sizes of a heating core of an exhaust heater when the exhaust gas is heated in accordance with a heating strategy. The method further includes selecting the volumetric size of the heating core that is associated with the lowest cumulative toxic emissions level obtained from the model solving for the cumulative toxic emissions at the various volumetric sizes of the heating core.

Accordingly, the volumetric size of the heating core, which heats the exhaust gas prior to the light-off catalyst, is optimized for the specific heating strategy to minimize toxic emissions, including but not limited to carbon monoxide emissions and hydrocarbon emissions, from the exhaust gas treatment system. Optimizing the size of the heating core is particularly effective for maximizing the efficiency of the exhaust gas treatment system in hybrid vehicles that employ pre-crank heating to pre-heat the heating core prior to starting the internal combustion engine.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic plan view of an exhaust gas treatment system.

FIG. 2 is a graph showing the relationship between cumulative hydrocarbon emissions leaving the exhaust gas treatment system and the volumetric size of the heating core.

### DETAILED DESCRIPTION

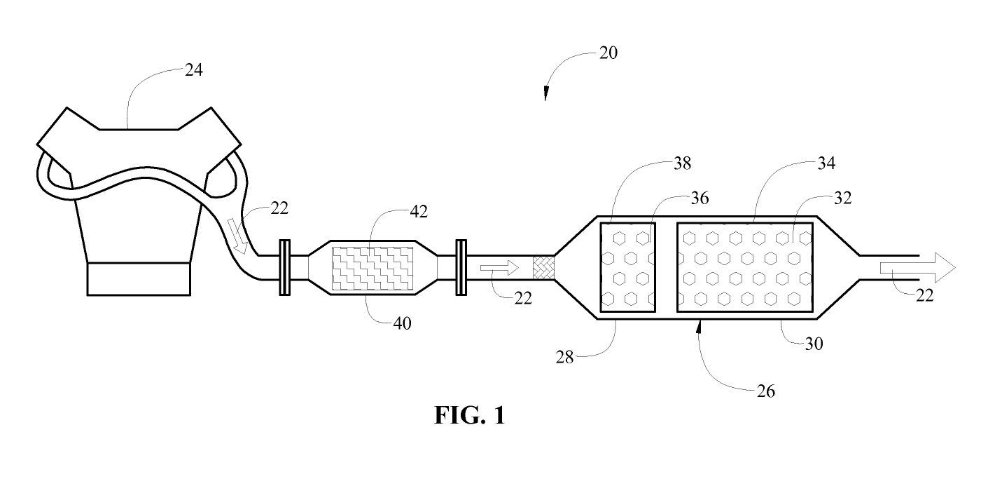

Referring to FIG. 1, wherein like numerals indicate like parts, an exhaust gas treatment system is shown generally at 20. The treatment system 20 treats a flow of exhaust gas, indicated by arrow 22, from an Internal Combustion Engine 24 (ICE) to reduce the toxicity of the exhaust gas, i.e., to reduce toxic emissions of the exhaust gas, including but not limited to, nitrogen oxides (NO), carbon monoxide (CO) and/or hydrocarbons (HC).

The treatment system 20 includes a main catalytic converter 26. The main catalytic converter 26 is disposed downstream of the engine 24. The main catalytic converter 26 may include, but is not limited to, a three way catalytic converter. The three way catalytic converter may include Platinum Group Metals (PGM), and converts a percentage of the nitrogen oxides in the exhaust gas into nitrogen and carbon dioxide or water, as well as oxidizes a percentage of the carbon monoxide to carbon dioxide and oxidizes a percentage of the unburnt hydrocarbons to carbon dioxide and water.

The main catalytic converter 26 includes an upstream portion 28 and a downstream portion 30. The downstream portion 30 includes a main catalyst 32 for treating the exhaust gas as described above. A main catalyst core 34 is disposed within the downstream portion 30, and supports the main catalyst 32.

The upstream portion 28 of the main catalytic converter 26 includes a light-off catalyst 36. The light-off catalyst 36 may include, but is not limited to PGM as the active component. A light-off catalyst core 38 is disposed within the upstream portion 28 of the main catalytic converter 26, and supports the light-off catalyst 36. The light-off catalyst 36 oxidizes the CO and HCs in the exhaust gas exothermally to produce heat, which helps heat the main catalyst 32 to a light-off temperature of the main catalyst 32 sufficient to react with the exhaust gas.

The treatment system 20 further includes an exhaust heater 40. The exhaust heater 40 is disposed upstream of the main catalytic converter 26. The exhaust heater 40 heats the exhaust gas prior to the exhaust gas entering the main catalytic converter 26. The exhaust heater 40 may include, but is not limited to, an electric heater 40. While the exhaust heater 40 is hereinafter referred to as the electric heater 40, it should be appreciated that the exhaust heater 40 may include some other device capable of heating the exhaust gas in accordance with a pre-defined heating strategy, described in greater detail below.

The electric heater 40 includes a monolithic heating core 42. The heating core 42 is heated through resistive heating of the heating core 42. Accordingly, an electric current is applied to the heating core 42, with the resistance of the heating core 42 generating heat, which is stored in the heating core 42 and/or transferred to the exhaust gas flowing through the heating core 42. It should be appreciated that the heating core 42 may be heated in some other manner not shown or described herein.

The electric heater 40 is powered to heat the exhaust gas in accordance with the heating strategy. If the vehicle is a conventional vehicle powered only by the internal combustion engine 24, then the electric heater 40 is powered by the engine 24 post-crank, i.e., post-crank heating after the engine 24 has started. If the vehicle is a hybrid vehicle powered by either the internal combustion engine 24 and/or a separate ICE/electric motor combination (not shown), then the electric heater 40 may be powered by either the engine 24 or the ICE/electric motor combination. Accordingly, if the vehicle is a hybrid vehicle, the electric heater 40 may be powered by a battery pre-crank, i.e., pre-crank heating before the engine 24 is started, or may alternatively be powered by the engine 24 post-crank. The heating strategy may include a pre-determined amount of time pre-crank heating at a pre-determined power level, or a combination of pre-crank heating for a pre-determined amount of time at a pre-determined power level and post-crank heating for a pre-determined amount of time at a pre-determined power level.

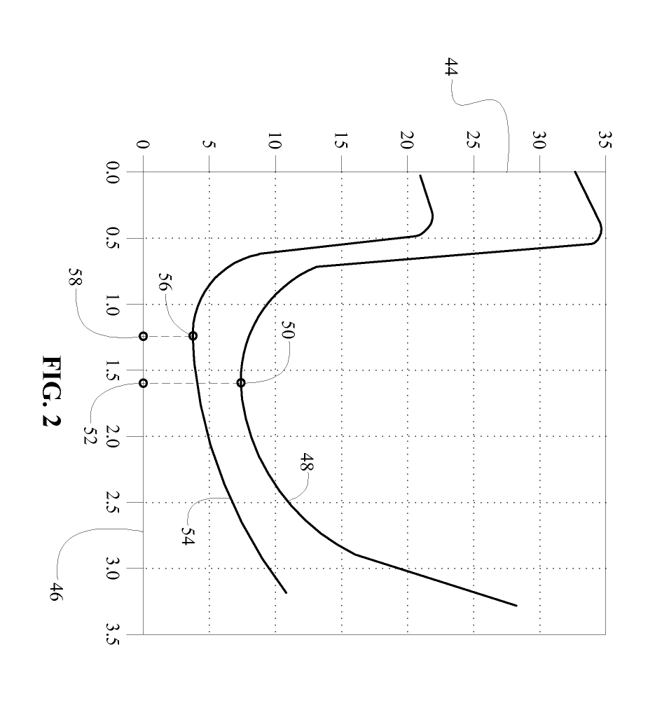

FIG. 2 shows the cumulative hydrocarbon emissions leaving the exhaust gas treatment system 20 after 250 seconds under the Federal Test Procedure drive cycle for hybrid vehicles. The Federal Test Procedure drive cycle for hybrid vehicles includes operating the vehicle for one hundred fifty seconds (150 sec) under battery power with the engine 24 off, followed by operating the vehicle for one hundred seconds (100 sec) under engine power, i.e., with the engine 24 on. While FIG. 2 optimizes the volumetric size of the heating core 42 to hydrocarbon emissions, it should be appreciated that the volumetric size of the heating core 42 may be optimized for other toxic emissions, including but not limited to carbon monoxide emissions. The cumulative hydrocarbon emissions are measured in milligrams per miles (mg/ml) along a vertical axis 44, and the volumetric size of the heating core 42 is measured in liters (l) along a horizontal axis 46.

Referring to FIG. 2, it has been found that the efficiency of the treatment system 20 varies with the volumetric size of the heating core 42 at any given heating strategy. If the heating core 42 includes a smaller volumetric size, the power applied to the heating core 42 in accordance with the heating strategy quickly produces higher temperatures within the heating core 42 and quickly transfers the stored heat to the exhaust gas. However, because of the small volumetric size of the heating core 42, and thereby the small heat storage capacity, the heat transfer to the exhaust gas flowing through the heating core 42 occurs only over a short period of time. If the heating core 42 includes a larger volumetric size, the power applied to the heating core 42 in accordance with the heating strategy produces lower temperatures within the heating core 42 and transfers the stored heat to the exhaust gas slowly. However, because of the large volumetric size of the heating core 42, and thereby a larger heat storage capacity, the heat transfer to the exhaust gas flowing through the heating core 42 occurs over a longer period of time. Accordingly, there exists an optimum volumetric size for the heating core 42 for any given heating strategy that minimizes the cumulative toxic emissions leaving the main catalytic converter 26. Any additional heat added to the exhaust gas from the electric heater 40 affects the relationship between the cumulative hydrocarbon emissions and the volumetric size of the heating core 42. Accordingly, the heating core 42 should be sized according to the specific heating strategy utilized to maximize the efficiency of the treatment system 20.

As shown in FIG. 2, a first relationship between the cumulative hydrocarbon emissions and the volumetric size of the light-off catalyst core 38 at a first heating strategy is shown at 48. The first heating strategy includes pre-crank heating the exhaust gas with the electric heater 40 at nine hundred watts (900 w) for one hundred fifty seconds (150 sec), followed by post-crank heating the exhaust gas with the electric heater 40 at zero watts (0 w) for zero seconds (0 sec). The minimum hydrocarbon emissions level under the first heating strategy is shown at 50, and the optimum volumetric size for the light-off catalyst core 38 under the first heating strategy is shown at 52. A second relationship between the cumulative hydrocarbon emissions and the volumetric size of the light-off catalyst core 38 at a second heating strategy is shown at 54. The second heating strategy includes pre-crank heating the exhaust gas with the electric heater 40 at nine hundred watts (900 w) for one hundred fifty seconds (150 sec), followed by post-crank heating the exhaust gas with the electric heater 40 at fifteen hundred watts (1500 w) for one hundred seconds (100 sec). The minimum hydrocarbon emissions level under the second heating strategy is shown at 56, and the optimum volumetric size for the light-off catalyst core 38 under the second heating strategy is shown at 58.

Referring back to FIG. 1, the invention provides a method of treating the flow of exhaust gas from the internal combustion engine 24 of a hybrid vehicle. The method of treating the flow of exhaust gas from the internal combustion engine 24 includes a method of sizing the volume of the heating core 42 of the electric heater 40.

The method of sizing the volume of the heating core 42 includes defining a heating strategy for heating the exhaust gas. The heating strategy may be defined to include only pre-crank heating at a pre-determined power level for a pre-determined period of time, or a combination of both pre-crank heating at a pre-determined power level for a pre-determined period of time, and post-crank heating at a pre-determined power level for a pre-determined period of time. The efficiency of the exhaust gas treatment system 20 is particularly benefited by employing a heating strategy that combines pre-crank heating with post-crank heating. This is because the hybrid vehicle may pre-heat the heating core 42 when being powered by the battery prior to starting the engine 24.

The volume of the heating core 42 of the electric heater 40 is sized to minimize toxic emissions in the exhaust gas when the exhaust gas is heated in accordance with the heating strategy. The toxic emissions may include, but are not limited to, hydrocarbon emissions or carbon monoxide emissions. Accordingly, the heating core 42 is sized to optimize performance and minimize either the hydrocarbon emissions or the carbon monoxide emissions

Sizing the heating core 42 may further include measuring the cumulative toxic emissions leaving the main catalyst 32 for various volumetric sizes of the heating core 42 under the defined heating strategy. As described above, the toxic emissions may include CO or HC. Accordingly, measuring the cumulative toxic emissions may be further defined as measuring the cumulative CO emissions from the exhaust gas or measuring the cumulative HC emissions from the exhaust gas. The measured cumulative toxic emissions may be used to develop a relationship between the cumulative toxic emissions and the volumetric sizes of the heating core 42 when the exhaust gas is heated in accordance with the defined heating strategy. The relationship between the cumulative toxic emissions and the volumetric size of the heating core 42 may include “curve fitting” a best fit line through the measured data points relating the cumulative toxic emissions at the various volumetric sizes of the heating core 42. The best fit line may be expressed graphically such that the lowest toxic emissions level under the defined heating strategy may be visually determined by viewing a graph relating the cumulative toxic emissions and the volumetric sizes of heating core 42 when the exhaust gas is heated in accordance with the defined heating strategy.

Sizing the volume of the heating core 42 includes selecting the volumetric size of the heating core 42 that is associated with the lowest cumulative toxic emissions level. The lowest cumulative toxic emissions level may be determined from the measured cumulative toxic emissions, or predicted from the model of the treatment system for the cumulative toxic emissions at the various volumetric sizes of the heating core 42. Referring to FIG. 2, the lowest cumulative hydrocarbon emission level is shown at markers 50 and 56 for the first relationship 48 under the first heating strategy and the second relationship 54 under the second heating strategy respectively. Accordingly, the size of the heating core 42 is determined from the lowest level of the cumulative hydrocarbon emissions, as indicated by markers 52 and 58 for the first relationship 48 under the first heating strategy and the second relationship 54 under the second heating strategy respectively.

Alternatively, the method of sizing the volume of the heating core 42 may include modeling the operation of the treatment system. The model of the treatment system may be used to predict the measured cumulative toxic emissions leaving the main catalyst 32 at the various volumetric sizes of the heating core 42 when the exhaust gas is heated in accordance with a heating strategy. The model may include, for example, a set of partial differential equations. The mathematical model of the treatment system 20 may be solved to obtain the level of toxic emissions leaving the main catalyst 32 at various times throughout the Federal Test Procedure under the defined heating strategy. Once the model is developed, then sizing the heating core 42 may include selecting the volumetric size of the heating core 42 that is associated with the lowest cumulative toxic emissions level obtained from the model solving for the cumulative toxic emissions at the various volumetric sizes of the heating core 42 when the exhaust gas is heated in accordance with the heating strategy

The method of treating the exhaust gas may further include heating the exhaust gas with the electric heater 40 in accordance with the heating strategy. The exhaust gas is heated to decrease the amount of time required to bring the light-off catalyst 36 and/or the main catalyst 32 up to their respective light-off temperatures. Heating the exhaust gas may include pre-crank heating, or a combination of pre-crank heating and post-crank heating as described above.

The method of treating the exhaust gas may further include exothermically oxidizing the CO and the HCs in the exhaust gas with the light-off catalyst 36. As described above, the light-off catalyst 36 is disposed downstream of the electric heater 40 and upstream of the main catalyst 32 to generate heat in the exhaust gas prior to reacting with the main catalyst 32 to decrease the time needed to heat the main catalyst 32 to the light-off temperature.

The method of treating the exhaust gas further includes treating the exhaust gas with the main catalyst 32, which is disposed downstream of the light-off catalyst 36, to reduce the toxicity of the exhaust gas as described above.

While the best modes for carrying out the invention have been described in detail, those familiar with the art to which this invention relates will recognize various alternative designs and embodiments for practicing the invention within the scope of the appended claims.

1. A method of treating a flow of exhaust gas from an internal combustion engine, the method comprising:
heating the exhaust gas with an exhaust heater in accordance with a heating strategy, wherein the exhaust heater includes a heating core sized to minimize toxic emissions in the exhaust gas when the exhaust gas is heated in accordance with the heating strategy;
exothermically oxidizing carbon monoxide and hydrocarbons in the exhaust gas with a light-off catalyst disposed downstream of the exhaust heater to generate heat; and
treating the exhaust gas with a main catalyst disposed downstream of the light-off catalyst to reduce toxic emissions in the exhaust gas.

2. A method as set forth in claim 1 further comprising defining a heating strategy for heating the exhaust gas.

3. A method as set forth in claim 2 wherein the heating strategy includes pre-crank heating at a pre-determined power level for a pre-determined period of time.

4. A method as set forth in claim 2 wherein the heating strategy includes both pre-crank heating at a pre-determined power level for a pre-determined period of time and post-crank heating at a pre-determined power level for a pre-determined period of time.

5. A method as set forth in claim 1 further comprising measuring the cumulative toxic emissions leaving the main catalyst for various volumetric sizes of the heating core when the exhaust gas is heated in accordance with the heating strategy.

6. A method as set forth in claim 5 further comprising selecting the volumetric size of the heating core that is associated with the lowest cumulative toxic emissions level from the measured cumulative toxic emissions at the various volumetric sizes of the heating core when the exhaust gas is heated in accordance with the heating strategy.

7. A method as set forth in claim 1 further comprising modeling the operation of the exhaust gas treatment system to predict the cumulative toxic emissions leaving the treatment system for various volumetric sizes of the heating core when the exhaust gas is heated in accordance with the heating strategy.

8. A method as set forth in claim 7 further comprising selecting the volumetric size of the heating core that is associated with the lowest cumulative toxic emissions level obtained from the model solving for the cumulative toxic emissions for the various volumetric sizes of the heating core.

9. A method as set forth in claim 1 wherein the toxic emissions include one of carbon monoxide emissions or hydrocarbon emissions.

10. A method of sizing a volume of a heating core for an exhaust heater of an exhaust gas treatment system, the method comprising:
measuring the cumulative toxic emissions leaving a main catalyst of the exhaust gas treatment system for various volumetric sizes of a heating core of an exhaust heater when the exhaust gas is heated in accordance with a heating strategy; and
selecting the volumetric size of the heating core that is associated with the lowest cumulative toxic emissions level from the measured cumulative toxic emissions at the various volumetric sizes of the heating core when the exhaust gas is heated in accordance with the heating strategy.

11. A method as set forth in claim 10 wherein the toxic emissions include one of carbon monoxide emissions or hydrocarbon emissions.

12. A method as set forth in claim 11 further comprising defining a heating strategy to include pre-crank heating at a pre-determined power level for a pre-determined period of time.

13. A method as set forth in claim 11 further comprising defining a heating strategy to include both pre-crank heating at a pre-determined power level for a pre-determined period of time and post-crank heating at a pre-determined power level for a pre-determined period of time.

14. A method of sizing a volume of a heating core for an exhaust heater of an exhaust gas treatment system, the method comprising:
modeling the operation of the gas treatment system to predict the cumulative toxic emissions leaving a main catalyst of the exhaust gas treatment system for various volumetric sizes of a heating core of an exhaust heater when the exhaust gas is heated in accordance with a heating strategy; and
selecting the volumetric size of the heating core that is associated with the lowest cumulative toxic emissions level obtained from the model solving for the cumulative toxic emissions at the various volumetric sizes of the heating core.

15. A method as set forth in claim 14 wherein the toxic emissions include one of carbon monoxide emissions or hydrocarbon emissions.

16. A method as set forth in claim 15 further comprising defining a heating strategy to include pre-crank heating at a pre-determined power level for a pre-determined period of time.

17. A method as set forth in claim 15 further comprising defining a heating strategy to include both pre-crank heating at a pre-determined power level for a pre-determined period of time and post-crank heating at a pre-determined power level for a pre-determined period of time.
